(19) United States
(12) Patent Application Publication
(10) Pub. No.: US 2004/0160307 A1
(43) Pub. Date: Aug. 19, 2004

(54) Method and device for accessing of documents

(75) Inventors: Heikki Saikkonen, Espoo (FI); Heikki Mannila, Espoo (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/732,190

(22) Filed: Dec. 10, 2003

(30) Foreign Application Priority Data
Dec. 11, 2002 (WO) PCT/IB02/05282

(51) Int. Cl. H04Q 1/00

(52) U.S. Cl. 340/5.74

(57) ABSTRACT

Invention proposes a method to handle people related information, and a device being capable of executing said method. For example in a meeting with other peoples with this method being activated, a computer or mobile handset collects all information connected to people present in one folder to provided a fast and easy access to documents that are related to the people present. So the if an access to this information is needed, it can be performed by at least a single input. The method simplifies the access to documents located on a first low power radio device, wherein said documents are related to a person. The method is based on an identification of a person by identifying a second low power radio device carried by said person. The method comprises receiving on said first low power radio device a device identification from said second low power radio device via a direct low power radio connection, relating said device identification to said person by means of previously stored data, retrieving documents being related to said person, and arranging said documents for access.

### CROSS-REFERENCE TO RELATED APPLICATION

Priority is claimed from International Application No. PCT/IB02/05282 filed Dec. 11, 2002 under 35 USC §119.

### BACKGROUND OF THE INVENTION

1. Technical Field

The present invention relates to low power radio communication devices in an office environment having data processing and identification capabilities. It also relates to a feature to simplify the access to digitally stored data in an electronic office with minimized user interaction. In detail, the invention relates to a method and device for accessing of documents and for simplifying the access to these documents located on a first low power radio device, wherein said documents are chosen and arranged for access in accordance with device identifications received from another low power radio device.

2. Discussion of Related Art

As society becomes more and more computerized, information that is related to people will be predominantly available in an electronic format (e-mails, etc.). Many times in meetings it would be practical and convenient to have all information related to nearby people readily accessible in one place, where it would be easy to access them.

The typical office worker receives and sends many e-mail messages and interacts face-to-face with many people. An often occurring feature of the face-to-face interactions happening in an office is searching for relevant messages among the e-mails or other electronically stored documents. Typically, the messages have been sent or received by one of the participants of the meeting and their names are mentioned in the header of the e-mail they talk about. Finding the relevant mail or other document can often take a considerable amount of time.

Presently there is no possibility of an automated intelligent file storage system that enables the individual user to access relevant data quickly and simply.

### DISCLOSURE OF INVENTION

Therefore it is desirable to have a system to replace this enormous amount of file administration to be done by a user.

It is further desirable to have a system enabling a user to access a huge amount of files related to a person in a simple and quick manner.

This invention relates to the automatic use of presence information obtained by Bluetooth or other short-range communication technologies to select the relevant messages or documents and to make them easily accessible to the participants of a discussion with an electronic device such as a PC.

According to a first aspect of the present invention a method for accessing documents is provided. Said method comprises receiving on a first device a device identification of a second device, defining on said first device a person identification related to said device identification of said second device, and collecting representations of documents that are related to said person identification under a common access point for accessing.

The receiving and said defining actions of the method can basically be used to translate a device identification into the identification of a person, which in turn can be used to identify documents being related to said person. Representations of documents that are related to said identified person can be collected under a common access point for access.

In another example embodiment said representations of said documents can be the document itself and/or a link to said document. In the access point the documents can be collected as a collection of links or documents, or as a collection of links and documents. The collection of links has the advantage that the calculation resources for providing said documents can be reduced. The collection of documents has the advantage of a faster access to said documents.

In an example embodiment of the present invention said device identification is received via a wireless communication connection between said first and second device. By using a wireless communication connection for execution the method can be executed in an environment with modem communication devices such as mobile phones, communicators or even wireless communication enabled name tags.

In another example embodiment said wireless communication connection is a low power radio connection. By using wireless communication technology such as Wireless LAN (Local Area Network), WLL (wireless local loop) DECT, the present invention can be applied to any kind of active or transponder like acting wireless electronic device.

In yet another example embodiment said low power radio connection is a Bluetooth connection. By using Bluetooth an increasing number of portable electronic devices can be used to employ the present invention. It is to be noted that the second device may only be used to identify a device and the person and may not be able to perform many other operations. One feature is the use of Bluetooth as an identification method and the use of this identification as a basis for information collecting, wherein a Bluetooth protocol can be used as an identification method and this identification can be employed as a base for information collecting.

By using Bluetooth as an identification method, for example between computer and mobile handset or between two handsets a standard communication medium can be used for identification and collecting information in one virtual place (folder, file etc.). For example in a meeting with other people with this method being activated, a computer or mobile handset will collect all information connected to people present in a virtual folder where the information can easily be seen and accessed. The information or documents in the folder can be provided only as links so that unnecessary copying or moving is avoided.

In a low power radio environment the method of the present invention may be embodied as illustrated in the following example, in order to simplify the access to person related data, when said person is nearby. The method uses a low power radio connection to detect and identify a device of a person, and then relates the device identification to a person, to determine the name or other properties of said person. By using a low power radio connection, it can be ensured that the identified person is actually very close or in the same room, from which it can be estimated that the person may want to access a document being related to him. The identification of the device can be performed via an UID (Unique identification number) stored in the LPRD (Low Power Radio Device), or via any other arbitrary or proprietary identification code.

Having identified a person the device can retrieve all documents that can be related to said person. Said documents can be retrieved as the documents themselves or as links to a respective storage or database. It is to be noted that the present invention is not to be restricted to a certain type of documents, as the documents can be e.g. text documents, bitmaps, video/audio sequences, e-mails, tables and software programs/tools.

Having identified or retrieved all documents that are related to the identified person, the documents are arranged for access. As can be seen the present invention provides a presence controlled “file-tracker” or “file-sweeper”.

In case the identification of a low power device can not be related to a person, the method can suppose to relate a LPRD identification to a person, or to simply ignore said LPRD identification. This can initially be done by user input on the at least one of the two devices connected and inserting a name, an E-mail address, a working group or a project. In the first contact the relation between a person has to be defined and in all following cases the device can retrieve this relation.

This invention enables easy access to person related information when the person in question is nearby. In case that more than one person is actually present, the device can separately retrieve and arrange the documents for access being related to one or more of the present persons.

In another example embodiment of the invention said wireless communication connection is an optical communication connection. Optical communication connections such as infrared interfaces are known in the state of the art. The present invention can also be applied to semi active optical systems such as scanners to identify an approaching and/or present and/or proximity device automatically. An embodiment of the present invention using an optical connection provides that the second device is in sight i.e. the other device has to be very close. A drawback of an optical system is that the user has to provide for the optical connection between the first device and the second device e.g. by placing the device on a table or a desk.

In an other example embodiment the present invention, said device identification is received via a wired communication connection between said first device and second device. Thereby devices such as Flash card memory modules or the like can be employed. A wired connection may be provided by an interface such as USB (universal serial bus) or “Firewire”.

In another example embodiment the method further comprises the detection of said second device when the device enters the range of said wireless connection or is activated within said range. The detection of the LPRD provides an indication that its owner is present. The detection together with the identification provides a presence indication for persons.

In yet another example embodiment said detecting comprises measuring and evaluating of parameters of said direct wireless connection (DWC). By measuring the signal strength the device can determine if the detected device is close or at the limit of the range of the DWC. Thereby it can be assured that the detected device is definitely within a visual or audible range or within the same office or room. A threshold for the received signal strength or the radiated power can be used to suppress devices being present in adjacent offices. A signal strength variation parameter can be used to detect if said device is actually moving and the identification can be suppressed. The parameters can be stored or selected in dependence of a device identification e.g. by distinguishing between an outdoor or indoor device or between different available radiation powers of different DWCs.

In yet another example embodiment the method further comprises displaying said collected representations of documents under said common access point on a display of said first electronic device. The documents can be displayed as a file, a folder, an application window, a (taskbar) icon or a compound/complex icon.

In another example embodiment of the method of the present invention said collecting of said documents in an access point is implemented by determining documents being related to said person, and sorting representations of said determined documents in a file. The file may be stored constantly or temporarily in a database. According to the settings of the WCED (wireless communication enabled device) the method can collect all documents that can be related to a certain person. The method can also be extended by a pre-selection of documents being restricted to the type of documents, or the time the document has been generated or changed. The file said representations of documents are arranged in, can be stored, at least for a pre-determined time. The file said representations are arranged in, can be a folder, a data file, a table, a tray or any other kind of data structure. The file can be embodied as a virtual personal link library being stored for e.g. a few minutes, a few hours or a few days. The presence of a person can be indicated by placing a picture of said person related to said identified WCED on the display or e.g. as an icon on a taskbar.

This feature can also provide a kind of privacy or safety application, wherein personal documents of the user are only available when the owner of the WCED device is determined (by his mobile phone or WCED enabled name badge) to be actually present.

In yet another example embodiment of the method said retrieving of documents comprises retrieving of a previously stored and possibly updated file containing said arranged and/or sorted representations of documents. The representations of documents can be arranged or sorted according to properties such as generation time or document type.

In another example embodiment the method further comprises detecting a representation of document being related to a person and updating said file in correspondence with said detected representation of said document. The representation of said document can e.g. be detected when an E-mail with a certain address or a certain sender is generated, received or sent. The generation or the update can comprise different user confirmation steps. Another application can further provide an approaching or presence alarm functionality, to alarm a user that a person is nearby, if the generated file contains a representation of a document that is marked with a notification sign. This can serve as a pocket reminder notifying that an action has to be performed with the detected person, providing an automated people specific presence notification system.

The file with a set of linked files can be generated and e.g. updated every ¼ hour or in the case a representation of a document is detected, received or generated containing a link to or an indication of a person. This can be executed by a program running in the background of the device, or by a software tool being implemented in a document processing program. This file update feature can be restricted to a pre-selectable list of important persons or regular visitors.

Another example embodiment further comprises the transfer of said file to said second WCED or ED. This is a first step of a file exchange between the two WCEDs to make the documents present on both WCEDs visible. The file can also be transferred as a link-library to reduce the power consumption of a mobile device. The transfer can be performed via the same or via another transfer channel or medium that was used to transfer said device information. The transferring can also comprise the transfer of the documents collected under said common access point or the common access point itself.

Yet another example embodiment of the method further comprises the reception of a second file comprising person related documents from a second LPRD, and incorporating said received documents into said arranged file. With this feature it is possible to make all documents being related to both meeting persons available for both persons in a single access point on each of their devices. This feature provides a central table where every person can see which documents the other has. This can be implemented by a two part list with onboard and remote documents. A third list or file can be used to list documents being present on both devices.

According to yet another aspect of the invention, a software tool is provided comprising program code means for carrying out the method of the preceding description when said program product is run on a computer or a network device.

According to another aspect of the present invention, a computer program product downloadable from a server for carrying out the method of the preceding sections is provided, which comprises program code means for performing the steps of the methods of the preceding description, when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer, or a network device.

According to another aspect of the present invention an electronic device (ED) for accessing documents located on said ED, wherein said documents are related to persons, is provided. The ED simplifies the access to said documents on the basis of an identification of a second electronic device carried by a person, and relating the identification to said person.

The ED comprises an interface module, a storage, a processing unit and a display. The interface module is for providing a direct low power radio connection to other EDs present within range, and for receiving device identifications from said connected EDs. Said storage is for storing relations between identifications and persons to relate the device identification to a person. Said storage is further adapted for storing documents being related to said persons. Said processing unit is connected to interface module for receiving said identification identifying a second device within range. Said processing unit is connected to said storage, relates said received device identification to persons, and retrieves or collects documents being related to said persons. Said processing unit is further configured to arrange, prepare and/or collect documents under a common access point for access. Said display is connected to said processing unit for displaying said arranged documents and/or said common access point.

In another example embodiment of the present invention said interface module comprises a low power radio interface module.

In another example embodiment said low power radio interface is a Bluetooth interface. By using Bluetooth, a common and widely spread technique can be used to provide the functionality of the present invention without being bound to proprietary devices such as low power radio enabled name badges or company employee identity cards. By using Bluetooth, the present invention can be applied to any Bluetooth enabled device such as PDAs, mobile phones, communicators, access control and security systems or even media players or digicams. The system can be used by everyone carrying a Bluetooth enabled device.

In yet another example embodiment of the present invention said interface module comprises an optical interface.

In yet another example embodiment said electronic device further comprises a mobile telephone. By integrating the ED in a mobile phone, it can be assured that the user is likely to be always in close to his ED.

### BRIEF DESCRIPTION OF THE DRAWINGS

In the following, the invention will be described in detail by referring to the enclosed drawings in which:

FIG. 1 is a flowchart of an embodiment of the method of the present invention, and

FIG. 2 is an example of a displaying the arranged documents on a display of a low power radio device.

### BEST MODE FOR CARRYING OUT THE INVENTION

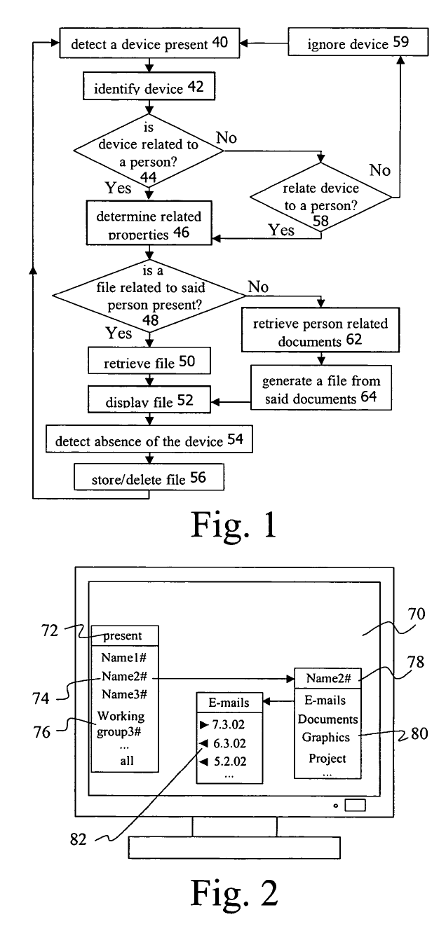

FIG. 1 describes a method of the present invention to provide a user with a set of pre-selected data or documents in a situation in which it is probable that one of these documents is going to be required. Supposing the following situation: person B walks into person A's office. Person B is carrying a portable Bluetooth enabled device such as a mobile phone, a PDA (Personal Digital Assistant) or an electronic employee identity card. The personal computer (PC) (or other Bluetooth enabled data processing device) on A's desk, equipped with Bluetooth, notices (40)B's Bluetooth enabled device being within range. The personal computer on A's desk identifies (42) B's Bluetooth device by the reception of identification data e.g. the unique device identifier, or e.g. a working group identification.

Assuming that the device of B has previously been “introduced” to the system on A's PC, the system knows a relation (44) between the identification of B's device and B's name or other characteristics of B or properties of B's device. The device identification is related to a set of properties which can be determined (46) by A's PC such as the name of B, B's e-mail address, a working group, a project and the like from a database. The device identification can also access a picture of B and depict it on the PC screen together with B's name and e-mail address.

This first step of the present invention can provide a device or people monitor, surveying the radio range of A's PC, for known and/or unknown people and Bluetooth devices. To provide such a surveillance feature, only a displaying operation has to be inserted between the operations 42 and 48.

In case A's PC can not find (44) a relation between the device identification and a person or other properties, A's PC can offer A a chance to relate identified device identification to a person (58) by user input, following an identification procedure. Person A can normally make or define the relation in block 58 and in block 46 the device can normally determine the relation. If such an identification is not performed, A's PC waits for the next detection (40) of a Bluetooth device within range. To prevent a repeated detection that would re-start the procedure (40 to 58) an “ignore-tag” can be set (59). The “ignore-tag” prevents that the procedure is re-started as long as the device is within range. This ignore-tag can be removed when the terminal moves away from detection area, so if the device returns into the coverage area it can be related to some person. This ignore-tag can may also be embodied as a user settable permanent ignore tag, to permanently take no account of certain identified devices being assigned to service personnel.

Having identified B's name and E-mail address, A's PC searches (62) for a previously stored data documents and files that can be related to B. The system on A's PC selects from A's e-mailbox the messages sent to or by B, and other messages related to B. A more sophisticated embodiment of the method can further search for enclosed documents, letters having B's name in the letter-header, or documents containing B's name.

A virtual folder comprising these documents is created (64) and placed (52) in an unobtrusive way on A's desktop. If A needs to access some messages or documents during a face-to-face discussion with B, then it is likely that the relevant document is inside said virtual folder.

If the face-to-face discussion A and B does not require any support from the documents and e-mails, the automated creation of the virtual folder does not disturb the discussion in any way.

For the operation of the method, the system has to know the correspondence between the B's Bluetooth device and the name of person B or other properties of B. When a previously unknown Bluetooth device becomes present in A's office, A can relate the name of B and the identity of B's device to each other (58). A's PC can then indicate that whenever B is present and a virtual folder is created.

The Bluetooth device on A's PC can detect (40) the presence of other Bluetooth devices by repeated polling. As the PC does not have to care about power constraints, it can poll e.g. every 10 seconds or at any other interval. Another possibility is that A's Bluetooth device is in an “always-on” mode, i.e., it detects automatically the presence of B's device.

A possible problem can arise if persons just walking by A's office are considered, erroneously, to be present. To prevent this the signal strength or the change in signal strength or other methods to determine that B's device is indeed inside A's office can be used and from which it can relatively certainly be inferred that A and B are having a discussion. Different thresholds can be set to ensure that B's device is actually present, these thresholds can be stored individually for each Bluetooth device.

The content of the virtual folder can be selected in various ways. A simple method on the example for selecting e-mail messages: select messages

sent by B

received from B

mentioning the name of B in the subject

or related to one of the above by Re:, Fwd: -chains (discussion threads)

Any other document type being related to B can be identified or retrieved in a similar way.

When B's device is no longer present (54), the virtual folder containing material related to B can be removed or stored (56). This is probably best done only after a suitable interval and if B is a repeated visitor in A's office, the folder can be semi-permanent or permanent. In case of a permanent folder the folder can automatically be updated, if a document or a message being related to B is received, detected or generated, ensuring that even unsent messages and “in work” documents are made available.

The same method can also be used in phone conversations. When person A receives a phone call from person B, often A needs to look at some documents associated with B. In this case A's Bluetooth-equipped phone sends an identification of B to A's PC, and A's PC creates the virtual folder as above.

The invention can also be used not only to activate or generate a single document file, when an approaching Bluetooth device is detected, but also to activate or deactivate certain application programs in the background. For example activate “Text Program” or “Document Reader” to provide a faster access to the documents in said file, providing a kind of an “approaching/present person program control”.

Depending on the computational power of B's Bluetooth device, it can also detect the presence of A by identifying A's PC and therefore execute the same steps as A's PC. This application is especially useful in case of meetings. In case of meetings and powerful Bluetooth devices such as PDAs, notebooks or communicators, all present persons can be detected and the device can generate different folders for each detected person even in the case of “out of office” meetings. The device can also generate a single folder with documents related to all present persons.

The basic components of the method, 42, 46, 62 and 52 are depicted in bold boxes.

A very simple and clear example of a possible implementation would be a filing cabinet with a lot of single files, wherein each file is provided with a small LED (light emitting diode). The cabinet would be provided with a database to relating the documents and files to different persons, working on them. The cabinet would also be provided with a Bluetooth device and an identification name relation database. An office clerk carrying a Bluetooth enabled name badge, approaching the cabinet can be recognized by the cabinet by identifying the name badge via Bluetooth and retrieving the name of the clerk by a relation. In a last step the cabinet switches on all the LED's of documents the clerk has worked on, simplifying the access by providing a visual pre-selection.

FIG. 2 depicts a display of a Bluetooth device according to one embodiment of the present invention. A presence folder (72) is depicted on a monitor (70) of a Bluetooth device (not shown), containing the names (74) and properties (76) of devices within the range of the Bluetooth device. The user of the device can open e.g. a file (78) related to Name2# containing the different document types (80) that can be related to the Name2#. By opening the E-mails, the device depicts a list (82) of E-mails according to their generation or reception dates. The small triangles besides the dates indicate mail as being an incoming or outgoing mail.

The displayed documents can be combined with an automatic time observation frame to prevent the “popup” of long forgotten emails stored somewhere and jamming the display with probably not necessary information. The file can also comprise a sub-sort feature like virtual folder for “project group” or specific information like “hobby#1” or “Golf Club”.

In the case that more than one person is detected, logically linked subfolders can be generated. For example, if the persons A and B are simultaneously detected, the folders comprising documents being related to A, B, A∪B and A∩B can be generated.

It is further to be noted that the invention can be extended to some kind of “virtual” identification presence sensor, wherein a user having actually forgotten his WCED or Bluetooth device simply can induce the generation of the virtual file by typing in a name in a respective user interface of the visited WCED.

It is to be noted that the method of the present invention can also be equipped with an adaptive contact or visitor protocol, to detect when and which person visits the office to improve the generation or the update of the files.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method for accessing documents, comprising:
receiving on a first device a device identification of a second device,
defining on said first device a person identification related to said device identification of said second device, and
collecting representations of documents that are related to said person identification under a common access point for accessing.

2. Method according to claim 1, wherein said representations of said documents comprise at least one of a group comprising the document itself and a link to said document.

3. Method according to claim 1, wherein said device identification is received via a wireless communication connection between said first device and said second device.

4. Method according to claim 3, wherein said wireless communication connection is a low power radio connection.

5. Method according to claim 4, wherein said low power radio connection is a Bluetooth connection.

6. Method according to claim 3, wherein said wireless communication connection is an optical communication connection.

7. Method according to claim 1, wherein said device identification is received via a wired communication connection between said first and second device.

8. Method according to claim 3, further comprising detecting said second device to be within the range of said direct wireless communication connection.

9. Method according to claim 7, wherein said detecting comprises measuring and evaluating of parameters of said direct wireless communication connection.

10. Method according to claim 1, further comprising displaying said collected documents under said common access point on a display of said first electronic device.

11. Method according to claim 1, wherein said collecting of said representations of said documents under said common access point comprises:
determining documents being related to said person, and
sorting said representations of said documents in a file.

12. Method according to claim 10, wherein said collecting of representations of said documents under a common access point comprises retrieving of a file containing said sorted representations of documents.

13. Method according to claim 10, further comprising:
detecting a representation of a document being related to a person, and
updating of said file comprising said representations of said documents in accordance with said detected representation of a document.

14. Method according to claim 10, further comprising:
transferring said file to said second device.

15. Method according to claim 10, further comprising:
receiving a second file comprising person related documents from a second low power radio device, and
incorporating said documents in said received file into said sorted file.

16. Software tool comprising program code means stored on a computer readable medium for carrying out the method of claim 1, when said software tool is run on a computer or network device.

17. Computer program product comprising program code means stored on a computer readable medium for carrying out the method of claim 1, when said program product is run on a computer or network device.

18. Computer program product comprising program code, downloadable from a server for carrying out the method of claim 1, when said program product is run on a computer or network device.

19. Computer data signal embodied in a carrier wave and representing a program that instructs a computer to perform the steps of the method of claim 1.

20. Electronic device for accessing documents comprising:
an interface module for receiving a device identification of a second electronic device,
a storage for storing relations between device identifications and persons, and for storing documents being related to said persons,
a processing unit being connected to said interface module and said storage, said processing unit being adapted for receiving said device identification from said second low power radio device, for relating said received device identification to a person, and for collecting documents being related to said person, wherein said processing unit is configured to arrange said collected documents under a common access point for access, and
a display connected to said processing unit for displaying said documents.

21. Electronic device according to claim 20, wherein said interface module comprises a low power radio interface module.

22. Low power radio device according to claim 21, wherein said low power radio interface module comprises a Bluetooth interface module.

23. Electronic device according to claim 20, wherein said interface module comprises an optical interface.

24. Electronic device according to claim 20, wherein said electronic device is a mobile telephone.
